(19) United States
(12) Patent Application Publication
(10) Pub. No.: US 2006/0182321 A1
(43) Pub. Date: Aug. 17, 2006

(54) Method and apparatus for extracting third ventricle information

(75) Inventors: Qingmao Hu, Singapore (SG); Aamer Aziz, Singapore (SG); Wieslaw Lucjan Nowinski, Singapore (SG)

Correspondence Address: DICKSTEIN SHAPIRO MORIN & OSHINSKY LLP, 2101 L Street, NW, Washington, DC, 20037, US

(73) Assignee: AGENCY FOR SCIENCE, TECHNOLOGY AND RESEARCH, Centros (SG)

(21) Appl. No.: 10/563,511

(22) PCT Filed: Jul. 6, 2004
(86) PCT No.: PCT/SG04/00202

§ 371 Date: Jan. 6, 2006

(30) Foreign Application Priority Data
Jul. 7, 2003 (SG) 200304160-5

(51) Int. Cl. G06K 9/00

(52) U.S. Cl. 382/128

(57) ABSTRACT

A method for extracting third ventricle information from images of a plurality of axial slices of a third ventricle of a brain comprises determining a midline for each of a number of the axial slices, determining the orientation of each of the midlines, generating a histogram of the orientations of the midlines, determining the peak of the histogram to provide a peak orientation, selecting the midlines having an orientation within a predetermined angle from the peak orientation and calculating the third ventricle plane from the midlines having an orientation within the predetermined angle from the peak orientation.

### FIELD OF THE INVENTION

The present invention is directed to a method and apparatus for extracting third ventricle information of a brain from images thereof.

### BACKGROUND OF THE INVENTION

Magnetic Resonance Imaging (MRI) can be used in diagnosis of various diseases in humans. The most important property to be considered in MRI is the stimulation of the tissue with various radio-frequency (RF) pulses at definite time intervals and then to detect the resultant echoes. The precise timing of the RF pulses is vitally important for good imaging. The RF pulses can be repeated at a certain rate (TR) and the echoes can be detected at a certain time (TE). The relative time lengths of TR and TE determine the pulse sequences and hence the tissue visualization.

The spin echo pulse sequence is the most commonly used pulse sequence. The pulse sequence timing can be adjusted to give T1-weighted, Proton or spin density, and T2-weighted images. The two variables of interest in spin echo sequences are the TR and TE. All spin echo sequences include a slice selective 90 degree pulse followed by one or more 180 degree refocusing pulses.

A short TR and short TE will give a T1-weighted image, a long TR and short TE will give a proton density image, and a long TR and long TE will give a T2-weighted image.

Fluid attenuated inversion recovery (FLAIR) is a type of inversion recovery sequence to give heavy T1-weighting. The basic part of an inversion recovery sequence is a 180 degree RF pulse that inverts the magnetization followed by a 90 degree RF pulse that brings the residual longitudinal magnetization into the x-y or transverse plane where it can be detected by an RF coil. The time between the initial 180 degree pulse and the 90 degree pulse is the inversion time (TI).

The spoiled gradient echo recovery (SPGR) sequence has the same TE and TR as T1-weighted sequence but has an additional variable flip/tip angle of the spins. The flip angle is usually at or close to 90 degrees for a spin echo sequence but commonly varies over a range of about 10 to 80 degrees with gradient echo sequences. The larger tip angles give more T1 weighting to the image and the smaller tip angle give more T2 or actually T2* weighting to the images.

The size and morphology of the third ventricle is important in clinical pathology. As the third ventricle is situated in a very critical part deep inside the brain, any lesion in the surrounding tissues would affect its shape and orientation. Mass lesion in the brain would cause mass effect and directly influence the orientation of the third ventricle.

Early intracerebral haemorrhage is difficult to visualise on CT images. The orientation of the third ventricle is key in its identification. As there is mass effect on one side, the third ventricle would shift from its midline position and its long axis would also change with respect to the symmetry plane of the skull. An efficient way to extract the third ventricle plane would facilitate the identification of the early intracerebral haemorrhage and localisation of the two landmarks, namely the anterior commissure AC and posterior commissure PC, for spatial normalisation of the human brain.

The size and width of the third ventricle are also important clinical parameters. The third ventricle may be enlarged in either generalised or localised hydrocephalus. The usual cause is blockage of the aqueduct of Sylvius¹. Patients with Alzheimer's disease ² bipolar disorders³ and manic depression⁴ have wider third ventricles. The width of the third ventricle better reflects the degree of cholinergic deficit than the severity of histopathological changes, such as scores of plaques and tangles in the brain of a patient with Alzheimer Disease⁵.

Existing methods for identifying the above-mentioned pathology conventionally use ventricle segmentation.

U.S. Pat. No. 6,434,030 describes an automated method and/or system for identifying suspected lesions in a brain based on the application of a segmentation technique to at least one of the masked images to classify the varying pixel intensities and differentiate hyper-intense regions.

U.S. Pat. No. 6,205,235 illustrates a method for non-invasive imaging of an anatomic tissue structure in isolation from surrounding tissues based on live-wire segmentation and boundary definition.

U.S. Pat. No. 6,208,347 describes a semi-automated method of MRI analysis based on mathematical modelling of MRI pixel intensity histograms.

WO 94/14132 describes a non-invasive scanning medical apparatus for generating an image of at least an interior region of a subject to be examined. The correlation of previous data to the scanned image is determined.

Methods which utilise segmentation techniques can run into problems and/or fail when there is a serious inhomogeneity and/or noise as such systems are highly vulnerable to noise, inhomogeneity and various artefacts such as pathology (which causes the loss of anatomical information).

The present invention aims to substantially overcome or ameliorate the above-mentioned problems and the measurement of the width of the third ventricle will facilitate the identification of pathology.

The method according to the present invention allows the anatomical knowledge to be implicitly incorporated in the intelligent sampling scheme.

The method finds application in medical imaging, in particular neuroimaging and provides ways for quantifying anatomical structures. Other areas of applications include neuroinformatics, neurosurgery, neuroradiology and brain research.

### SUMMARY OF THE INVENTION

The invention is directed to a method and apparatus for quantifying the third ventricle without segmentation and specifically, the extraction of the third ventricular plane and calculation of the width of the third ventricle of the human or animal brain in neuroimages through intelligent sampling of anatomical structures around the third ventricle.

According to a first aspect of the present invention there is provided a method for extracting third ventricle information from images of a plurality of axial slices of a third ventricle of a brain having an anterior commissure and a posterior commissure, the third ventricle having a third ventricle plane and a width, the method comprising:
a. determining a third ventricle midline for each of a number of the axial slices;
b. determining the orientation of each of the midlines;
c. generating a histogram of the orientations of the midlines;
d. determining the peak of the histogram to provide a peak orientation;
e. selecting the midlines having an orientation within a predetermined angle from the peak orientation; and
f. calculating the third ventricle plane from the midlines having an orientation within the predetermined angle from the peak orientation.

Preferably, the step of calculating the third ventricle plane comprises calculating the least square fit plane of the midlines having an orientation within the predetermined angle from the peak orientation.

In a preferred embodiment, the step of calculating the third ventricle plane further comprises:
(i) calculating the maximum distance from the least square fit plane to the midlines having an orientation within the predetermined angle from the peak orientation,
(ii) generating a histogram of the maximum distance of the midlines having an orientation within the predetermined angle from the peak orientation to the least square fit plane,
(iii) determining the peak of the histogram of the maximum distance of the midlines to the least square fit plane,
(iv) selecting the midlines lying within a predetermined distance of the peak, and
(v) recalculating the least square fit plane using the selected midlines to generate the third ventricle plane.

Preferably, the method further comprises calculating the width of the third ventricle, by for example, determining the axial slice having the anterior commissure and the posterior commissure, determining two lines parallel to the third ventricle plane in said determined slice, said two lines being tangential to the image of the third ventricle in said slice to indicate the boundary between the third ventricle and grey matter, and calculating the distance between the two parallel lines, said distance being representative of the width of the third ventricle.

Preferably, the step of determining the third ventricle midline for each of a number of the axial slice sᵢ comprises calculating the local symmetry index of a searching line segment, the third ventricle midline being the searching line segment that has the minimum local symmetry index.

The local symmetry index lsi(x,y,sᵢ, θ) may be calculated according to the following:

$$\vert ls ( x , y , {s}_{i} , θ ) \vert ⨯ lsi ( x , y , {s}_{i} , θ ) = {\sum }_{{( x , y ) k}_{ss}} \sum DifG ( {x}_{s} , {y}_{s} , {s}_{i} , k )$$

where:
|is(x,y,sᵢ,θ)| is the length of the searching line segment,
Is(x,y,sᵢθ) is the searching line segment of voxel (x,y,sᵢ) with the searching angle θ, and (x,y,sᵢ) the searching point,
cos (90°+θ) is denoted as c90θ,
sin (90°+θ) is denoted as s90θ,
fabs (g(xₛ+k×c90θ, yₛ+k×s90θ, sᵢ)−g(xₛ−k×c90θ, yₛ−k×s90θ, sᵢ)) is denoted as DifG (xₛ, yₛ, sᵢ,k), where fabs is the absolute value function, the contribution of voxel (xₛ, yₛ,sᵢ) to Isi (x, y, sᵢ,θ) being:
DifG(xₛ,yₛ,sᵢ,0.5)+DifG(xₛ,yₛ,sᵢ,1.0)+DifG(xₛ,yₛ,sᵢ,3.0)+DifG(xₛ,yₛ,sᵢ,5.0)+DifG(xxₛ,yₛ,sᵢ,7.0).

In a preferred embodiment, the step of determining the axial slice having the anterior commissure and the posterior commissure comprises:
(1) calculating the x co-ordinate of the voxel xᵢ for all of the axial slices where the third ventricle is present such that this voxel's y co-ordinate is the mass centre of sᵢ y_{c}, and (xᵢ, y_{c}, sᵢ) is on the third ventricle plane, that is xᵢ=−(d+c sᵢ+b y_{c})/a, where (a, b, c) is a unit normal vector and d is a non-positive constant;
(2) generating the searching line segment from (xᵢ, y_{c}, sᵢ) such that the line segment is on the third ventricle plane and its centre is (xᵢ y_{c}, sᵢ);
(3) calculating the average grey level avgᵢ of the searching line segment;
(4) comparing the average grey level avgᵢ for different axial slices sᵢ and determining the axial slice having the anterior commissure and the posterior commissure.

Preferably, the step of determining the axial slice having the anterior commissure and the posterior commissure comprises for T1-, PD-weighted, FLAIR, and SPGR MR datasets, determining the axial slice with minimum average grey level avgᵢ, and for T2-weighted MR datasets it preferably comprises determining the axial slice with maximum average grey level avgᵢ.

According to a second aspect of the invention there is provided apparatus arranged to perform a method for extracting third ventricle information from images defined above.

According to a third aspect of the invention there is provided a computer program product comprising computer program instructions readable by a computer apparatus to cause the computer apparatus to perform a method defined above.

### BRIEF DESCRIPTION OF THE DRAWINGS

The present invention will now be described with reference to the sole FIGURE,

FIG. 1, which is a flow diagram illustrating the steps involved in an algorithm according to an embodiment of the present invention.

### DESCRIPTION OF PREFERRED EMBODIMENTS

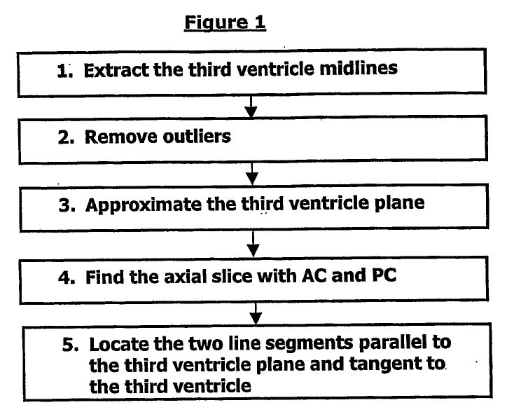

The steps constituting a preferred embodiment of the method of the present invention are shown in the flow diagram of FIG. 1. The method of the present invention, will be discussed in more detail after a brief discussion of these steps.

Given the radiological images of the brain under consideration and the starting and ending axial slice (sₒ and sₙ) where the third ventricle is present the processing steps illustrated in the flow diagram of FIG. 1 are as follows:

Step 1—extract the third ventricle midline segments for all of the axial slices in between the starting and ending axial slices sₒ and sₙ inclusive;

Step 2—remove outliers of the extracted midline segments;

Step 3—calculate the third ventricle plane (PV3) from the extracted third ventricle midline segment inliers;

Step 4—find the axial slice (APC) in between the starting and ending axial slices sₒ and sₙ where the anterior commissure (AC) and posterior commissure (PC) are present; and

Step 5—in the aforementioned axial slice (APC) locate the two line segments parallel to the third ventricle plane (PV3) and tangential to the third ventricle, the distance between them is taken as the width of the third ventricle.

A brain dataset or volume is represented as a stack of parallel two-dimensional slices. The three dimensional volume is denoted as Vol (x,y,z) with x, y and z being the co-ordinates at voxel (x,y,z). In this case, x, y and z are non-negative integers satisfying 0 x Xsize, 0 y Ysize, 0 z Zsize where the z co-ordinate is constant on the axial slices, the y co-ordinate is constant on the coronal slices and the x co-ordinate is constant on the sagittal slices.

If the original scanning orientation is coronal or sagittal, the axial slices are obtained by reorienting the original volume by reordering its voxels. The algorithm of the present invention works on the axial slices. The beginning and ending axial slices s₀ and sₙ where the third ventricle is present are predetermined. Any axial slice in between s₀ and sₙ is denoted as sᵢ, where sᵢ itself represents the axial slice as well as the axial slice number. The grey level at voxel (x,y,sᵢ) is denoted as g (x,y,sᵢ). From voxel (x,y,sᵢ) numerous line segments can be drawn within sᵢ. The line segment is denoted as Is (x,y,sᵢθ) taking (x,y,sᵢ) as its centre, with the length of line segment being a constant L (for example, 60 mm) and the angle with respect to the y axis being θ. Is (x,y,sᵢθ) is called the searching line segment of voxel (x,y,sᵢ) with the searching angle θ, and (x,y,sᵢ) is called the searching point.

Step 1: Extract the Third Ventricle Midline Segments

A prominent feature of the third ventricle in axial slices is that the thalamus (grey matter, GM) and the third ventricle (cerebrospinal fluid, CSF) are substantially symmetrical with respect to the third ventricle midline. On axial slices, the length of the third ventricle may be up to 40 mm and its width may vary between around 3 mm to 10 mm. The centre of the third ventricle is around the mass centre of the axial slice.

To locate the third ventricle midline in an axial slice si, the local symmetry index of a searching line segment is used to capture the anatomical features of the third ventricle midline segment and thus to locate the third ventricle midline. Due to the variations in size of third ventricles, the local symmetry index should sample both the grey matter (GM) and cerebrospinal fluid (CSF).

For the searching line segment Is (x,y,sᵢ,θ), its local symmetry index Isi (x,y,sᵢ,θ) measures the grey level symmetry around it. For each voxel (xₛ,yₛ, sᵢ) on the searching line segment, five pairs of sampling points at the opposite sides of Is (x,y,sᵢ,θ) are taken on the lines perpendicular to Is (x,y,sᵢ,θ) and passing through (xₛ,yₛ,sᵢ) with the distance to Is (x,y,sᵢ,θ) preferably being 0.5 mm, 1 mm, 3 mm, 5 mm and 7 mm respectively.

cos (90°+θ) is denoted as c90θ

sin (90°+θ) is denoted as s90θ

fabs(g(xₛ+k×c90θ,yₛ+k×s90θ,sᵢ)−g(xₛ−k×c90θ,yₛ−k×s90θ,sᵢ)) is denoted as DifG (xₛ, yₛ, sᵢ,k)

The contribution of voxel (xₛ, yₛ,sᵢ) to Isi (x, y, sᵢ,θ) is:
DifG(xₛ,yₛ,sᵢ,0.5)+DifG(xₛ,yₛ,sᵢ,1.0)+DifG(xₛ,yₛ,sᵢ,3.0)+DifG(xₛ,yₛ,sᵢ,5.0)+DifG(xₛ,yₛ,sᵢ,7.0)
where fabs( ) is the absolute value function.

Isi(x,y,sᵢ,θ) is the average contribution of all the voxels on Is(x,y,sᵢ,θ), that is,

$$\vert ls ( x , y , {s}_{i} , θ ) \vert ⨯ lsi ( x , y , {s}_{i} , θ ) = {\sum }_{{( x , y ) k}_{ss}} \sum DifG ( {x}_{s} , {y}_{s} , {s}_{i} , k )$$

where |Is(x,y,sᵢ,θ)| is the length of the searching line segment in millimeters (mm).

The third ventricle midline segment on axial slice sᵢ is the searching line segment that has the minimum local symmetry index. The extracted third ventricle midline segment is called the approximated third ventricle midline segment (ATVMS).

Step 2: Remove Outliers of the Extracted Midline Segments

The approximated third ventricle midline segments (ATVMSs) are processed in two steps, to remove outliers, in the manner described for example in the applicants copending International Patent Application PCT/SG02/00231, the content of which is incorporated herein by way of reference.

Firstly, the orientations of all the ATVMSs are calculated and a histogram of the orientations is obtained. The peak of the histogram is determined and is called the peak orientation. Those ATVMSs with an orientation deviating from the peak orientation by more than a predetermined value, for example 1°, are considered as orientation ‘outliers’ while the rest of the ATVMSs are considered to be orientation ‘inliers’.

Secondly, the least square fit plane of the orientation inliers is calculated. The maximum distance of all the orientation inliers to this plane is calculated and the peak of the histogram of all the distances is obtained. Those orientation inliers with a distance deviating from the peak distance by more than a value of, for example 1 mm, are considered the third ventricle plane outliers, while the rest of the orientation inliers are considered as the third ventricle inliers.

Step 3: Calculate the Third Ventricle Plane

The third ventricle plane is approximated from the third ventricle inliers using, for example, the least square fit plane of the third ventricle inliers. The third ventricle plane is denoted as:
ax+by+cz+d=0
where (a, b, c) is a unit normal vector and d is a non-positive constant.
Step 4: Find the Axial Slice with the Anterior and Posterior Commissures

Any method for identification of the anterior commissure (AC) and posterior commissure (PC) may be used to locate the axial slice with the two commissures thereon (APC). This may also be identified in the following way:

1. Calculate the x co-ordinate of the voxel xᵢ for all of the axial slices sᵢ in between the beginning and ending axial slices s₀ and sₙ where the third ventricle is present such that this voxel and the mass centre of sᵢ have the same y coordinate y_{c}, and (xᵢ, y_{c}, sᵢ) is on the third ventricle plane, that is xᵢ=−(d+c sᵢ+b y_{c})/a.

2. Form the searching line segment from (xᵢ, y_{c}, sᵢ) such that the line segment is on the third ventricle plane and its centre is (xᵢ y_{c}, sᵢ).

3. Calculate the average grey level of the searching line segment. For the axial slice sᵢ, the calculated average grey level is denoted as avgᵢ.

4. Compare the average grey level avgᵢ for different axial slices sᵢ. For T1-, PD-weighted, FLAIR, and SPGR MR datasets, the axial slice with minimum avgᵢ is taken as APC. For T2-weighted MR datasets, the axial slice with maximum avgᵢ is taken as APC.

5. Calculate the third ventricle width by locating the left-most and right-most lines parallel to the third ventricle plane and tangential to the third ventricle in the APC, that is the boundary between the third ventricle and the grey matter. The distance between the two parallel lines is defined as the third ventricle width.

In summary, the present invention is directed to a method of extracting the third ventricle plane which is robust to noise, inhomogeneity and various artefacts. It is also directed to calculating the width of the third ventricle of a brain from neuro images.

Extracting the third ventricle plane and measuring the width of the third ventricle is of clinical importance for both pathology detection and morphological description of brains. The present invention proposes a fast and automatic method for quantifying the third ventricle based on intelligent sampling of anatomical structures, namely the thalamus and the third ventricle, around the third ventricle based on the combination of anatomical knowledge and image analysis technique.

In contrast to conventional methods in which the third ventricle is segmented, the method embodying the present invention extracts the midlines of the third ventricle based on the local symmetry of the cerebrospinal fluid (the third ventricle) and the grey matter (the thalamus). The third ventricle plane is taken to be the least square fit plane of all the midlines of the third ventricle. The width of the third ventricle is calculated as the distance between two lines parallel to the third ventricle plane and tangential to the third ventricle on the axial slice containing the anterior and posterior commissures.

### REFERENCES

1. Kim D. D. and Choi J. U., Huh R, Yun P. H., Kim D. I.—Quantitative Assessment of Cerebrospinal Fluid Hydrodynamics Using a Phase-Contrast Cine MR Image in Hydrocephalus. Childs Nerv the Syst 1999 September; 15 (9): 461-7.
2. Soininen H, Reinikainen K. J., Puranen M, Helkala E-L, Paljarvi L, Riekkinen P. J.—Wide 3^{rd} Ventricle correlates with Low Chlorine acetyltransferase activity of the neocortex in Alzheimer patients—Alzheimer Dis. Assoc Disord 1993; 7: 39-47.
3. Beyer J. L., Krisnan K. R.—Volumetric Brain Imaging Findings in Mood Disorders—Bipolar Disord. 2002, April; 4(2): 89-104.
4. Ali S. O., Denicoff K. D., Altshuler L. L., Hauser P, Li X, Conrad A. J., Smith-Jackson E. E., Leverich G. S., Post R. M.—Relationship Between Prior Course of Illness and Neuroanatomic Structures in Bipolar Disorder—A Preliminary Study—Neuropsychiatry, Neuropsychol. Behav, Neurol 2001 October-December; 14 (4); 227-32.
5. Soininen H, Reinikainen K. J., Puranen M, Helkala E-L, Paljarvi L, Reikkinen P. J.—Wide Third Ventricle Correlates with Low Choline Acetyltransferase Activity of the Neocortex in Alzheimer patients—Alzheimer Dis. Assoc Disord 1993; 7: 39-47).

1. A method for extracting third ventricle information from images of a plurality of axial slices of a third ventricle of a brain having an anterior commissure and a posterior commissure, the third ventricle having a third ventricle plane and a width, the method comprising:
(a) determining a third ventricle midline for each of a number of the axial slices;
(b) determining the orientation of each of the midlines;
(c) generating a histogram of the orientations of the midlines;
(d) determining the peak of the histogram to provide a peak orientation;
(e) selecting the midlines having an orientation within a predetermined angle from the peak orientation; and
(f) calculating the third ventricle plane from the midlines having an orientation within the predetermined angle from the peak orientation.

2. A method according to claim 1 wherein the step of calculating the third ventricle plane comprises calculating the least square fit plane of the midlines having an orientation within the predetermined angle from the peak orientation.

3. A method according to claim 2 wherein the step of calculating the third ventricle plane further comprises:
(i) calculating the maximum distance from the least square fit plane to the midlines having an orientation within the predetermined angle from the peak orientation,
(ii) generating a histogram of the maximum distance of the midlines having an orientation within the predetermined angle from the peak orientation to the least square fit plane,
(iii) determining the peak of the histogram of the maximum distance of the midlines to the least square fit plane,
(iv) selecting the midlines lying within a predetermined distance of the peak, and
(v) recalculating the least square fit plane using the selected midlines to generate the third ventricle plane.

4. A method according to any one of the preceding claims, further comprising calculating the width of the third ventricle.

5. A method according to claim 4, wherein the step of calculating the width of the third ventricle comprises determining the axial slice having the anterior commissure and the posterior commissure, determining two lines parallel to the third ventricle plane in said determined slice, said two lines being tangential to the image of the third ventricle in said slice to indicate the boundary between the third ventricle and grey matter, and calculating the distance between the two parallel lines, said distance being representative of the width of the third ventricle.

6. A method according to any one of the preceding claims, wherein the step of determining the third ventricle midline for each of a number of the axial slice sᵢ comprises calculating the local symmetry index of a searching line segment, the third ventricle midline being the searching line segment that has the minimum local symmetry index.

7. A method according to claim 6, wherein the local symmetry index Isi(x,y,sᵢ, θ) is calculated according to the following:
$$\vert ls ( x , y , {s}_{i} , θ ) \vert ⨯ lsi ( x , y , {s}_{i} , θ ) = {\sum }_{{( x , y ) k}_{ss}} \sum DifG ( {x}_{s} , {y}_{s} , {s}_{i} , k )$$
where:

|Is(x,y,sᵢ,θ)| is the length of the searching line segment,
Is (x,y,sᵢθ) is the searching line segment of voxel (x,y,sᵢ) with the searching angle θ, and (x,y,sᵢ) the searching point,
cos (90°+θ) is denoted as c90θ,
sin (90°+θ) is denoted as s90θ,
fabs (g(xₛ+k×c90θ, yₛ+k×s90θ, sᵢ)−g(xₛ−k×c90θ,yₛ−k×s90θ, sᵢ)) is denoted as DifG (xxₛ, yₛ, sᵢ,k), where fabs is the absolute value function, the contribution of voxel (xₛ, yₛ,sᵢ) to Isi (x, y, s_{i,}θ) being:
DifG(xₛ, yₛ, sᵢ, k1)+DifG(xₛ, yₛ, sᵢ, k2)+DifG(xₛ, yₛ, sᵢ, k3)+DifG(xₛ, yₛ, sᵢ, k4)+DifG(xₛ, yₛ, sᵢ, k5), k1, k2, k3, k4, and k5 are constants.

8. A method according to claim 7, wherein k1 is around 0.5 mm.

9. A method according to claim 7, wherein k2 is around 1 mm.

10. A method according to claim 7, wherein k3 is around 3 mm.

11. A method according to claim 7, wherein k4 is around 5 mm.

12. A method according to claim 7, wherein k5 is around 7 mm.

13. A method according to claim 5, wherein the step of determining the axial slice having the anterior commissure and the posterior commissure comprises:
(1) calculating the x co-ordinate of the voxel xᵢ for all of the axial slices where the third ventricle is present such that this voxel's y co-ordinate is the mass centre of sᵢ y_{c}, and (xᵢ, y_{c}, sᵢ) is on the third ventricle plane, that is xᵢ=−(d+c sᵢ+b y_{c})/a, where (a, b, c) is a unit normal vector and d is a non-positive constant;
(2) generating the searching line segment from (xᵢ, y_{c}, sᵢ) such that the line segment is on the third ventricle plane and its centre is (xᵢ y_{c}, sᵢ);
(3) calculating the average grey level avgᵢ of the searching line segment;
(4) comparing the average grey level avgᵢ for different axial slices sᵢ and determining the axial slice having the anterior commissure and the posterior commissure.

14. A method according to claim 13 wherein the step of determining the axial slice having the anterior commissure and the posterior commissure comprises for T1-, PD-weighted, FLAIR, and SPGR MR datasets, determining the axial slice with minimum average grey level avgi.

15. A method according to claim 13 wherein the step of determining the axial slice having the anterior commissure and the posterior commissure comprises for T2-weighted MR datasets comprises determining the axial slice with maximum average grey level avgᵢ.

16. An apparatus arranged to perform a method for extracting third ventricle information from images according to any one of the preceding claims.

17. A computer program product comprising computer program instructions readable by a computer apparatus to cause the computer apparatus to perform a method according to any one of claims 1 to 15.
